(19) United States
(12) Patent Application Publication
(10) Pub. No.: US 2022/0333943 A1
(43) Pub. Date: Oct. 20, 2022

(54) METHOD, APPARATUS, AND COMPUTER PROGRAM PRODUCT FOR DETERMINING FAMILIARITY OF A PERSON WITHIN A GEOGRAPHIC REGION

(71) Applicant: HERE GLOBAL B.V., Eindhoven (NL)

(72) Inventors: Jerome BEAUREPAIRE, Berlin (DE); Leon STENNETH, Chicago, IL (US); Jeremy Michael YOUNG, Chicago, IL (US)

(21) Appl. No.: 17/301,924

(22) Filed: Apr. 19, 2021

(51) Int. Cl. G01C 21/34

(52) U.S. Cl. CPC G01C 21/3484

(57) ABSTRACT

Provided herein is a method for determining the familiarity of a person with a geographic area based on their mobility data compared against baseline mobility data, and leveraging the familiarity to inform those less familiar and to inform travel within the geographic area. Methods may include: receiving probe data from a plurality of first probe apparatuses within a geographic region; determining, from the probe data, a baseline mobility model; receiving probe data from a second probe apparatus within the geographic region; determining a second mobility model of the second probe apparatus; determining, based at least in part on the baseline mobility model, a mobility efficiency of the second mobility model; and providing, to a user of the second probe apparatus, instructions relating to mobility to improve mobility efficiency of the user of the second probe apparatus.

### TECHNOLOGICAL FIELD

Example embodiments described herein relate generally to determining and quantifying the familiarity of a person with a geographic area, and more particularly, to determining the familiarity of a person with a geographic area based on their mobility data compared against baseline mobility data, and leveraging the familiarity to inform those less familiar and to inform travel within the geographic area.

### BACKGROUND

Maps have evolved from static snapshots of a region on paper to become digital living documents that provide information far beyond conventional paper maps. These digital maps can be used for, among other things, providing navigational assistance to people through a region. The rich data used by map services providers can enhance the utility of these digital maps by providing routing and navigational assistance that is informed by mobility data such as traffic.

Beyond navigation, digital maps can provide information relative to points-of-interest such as restaurants, shops, historical buildings and artifacts, recreational facilities, or the like. Different people may use digital maps for different purposes. While some may employ a map solely to efficiently travel from an origin to a destination, others may use a map to navigate a new area and to find places that are of interest to them. Further, the way in which people use digital maps over time may change.

### BRIEF SUMMARY OF EXAMPLE EMBODIMENTS

At least some example embodiments are directed to determining the familiarity of a person with a geographic area, and more particularly, to determining the familiarity of a person with a geographic area based on mobility data, and leveraging the familiarity to inform those less familiar and to inform travel within the geographic area. Embodiments may provide an apparatus including at least one processor and at least one memory including computer program code, the at least one memory and the computer program code may be configured to, with the processor, cause the apparatus to at least: receive probe data from a plurality of first probe apparatuses within a geographic region; determine, from the probe data, a baseline mobility model; receive probe data from a second probe apparatus within the geographic region; determine a second mobility model of the second probe apparatus; determine, based at least in part on the baseline mobility model, a mobility efficiency of the second mobility model; and generate a report related to the mobility efficiency of the second mobility model.

According to some embodiments, the baseline mobility model includes a model of mobility within the geographic region established to be representative of efficient movement within the geographic region. Causing the apparatus to determine, from the probe data, a baseline mobility model includes causing the apparatus to: determine local probe apparatuses of the plurality of first probe apparatuses to be of a predetermined familiarity with the geographic region; and identify routes between origin and destination pairs as efficient routes between the origin and destination pairs in response to the routes being traversed by local probe apparatuses.

Causing the apparatus of some embodiments to determine local probe apparatuses of the plurality of first probe apparatuses to be of a predetermined familiarity with the geographic region includes causing the apparatus to identify probe apparatuses of the plurality of first probe apparatuses that travel along paths to a respective destination with less than a predetermined amount of hesitation or deviation from a fastest path to the respective destination. Causing the apparatus of some embodiments to determine, based at least in part, on the baseline mobility model, a mobility efficiency of the second mobility model includes causing the apparatus to: determine deviations of the second mobility model from the baseline mobility model within the geographic region; and quantify the deviations of the second mobility model from the baseline mobility model.

According to some embodiments, the apparatus is further caused to provide route recommendations to a user of the second probe apparatus for a route to a destination that is at least one of faster or less costly than a planned route of the user of the second probe apparatus. The apparatus of some embodiments is further caused to provide a recommendation of a sub-region of the geographic region that a user of the second probe apparatus is determined to be unfamiliar with. The apparatus of some embodiments is further caused to determine the user of the second probe apparatus to be unfamiliar with the sub-region of the geographic region in response to less than a predetermined threshold of probe data from the second probe apparatus being associated with locations within the sub-region of the geographic region.

Embodiments provided herein include a computer program product including at least one non-transitory computer-readable storage medium having computer-executable program code instructions stored therein, the computer-executable program code instructions including program code instructions to: receive probe data from a plurality of first probe apparatuses within a geographic region; determine, from the probe data, a baseline mobility model; receive probe data from a second probe apparatus within the geographic region; determine a second mobility model of the second probe apparatus; determine, based at least in part on the baseline mobility model, a mobility efficiency of the second mobility model; and generate a report related to the mobility efficiency of the second mobility model.

The baseline mobility model of some embodiments is a model of mobility within the geographic region established to be representative of efficient movement within the geographic region. The program code instructions to determine, from the probe data, a baseline mobility model includes program code instructions to: determine local probe apparatuses of the plurality of first probe apparatuses to be of a predetermined familiarity with the geographic region; and identify routes between origin and destination pairs as efficient routes between the origin and destination pairs in response to the routes being traversed by local probe apparatuses. The program code instruction to determine local probe apparatuses of the plurality of first probe apparatuses to be of a predetermined familiarity with the geographic region includes program code instructions to: identify probe apparatuses of the plurality of first probe apparatuses that travel along paths to a respective destination with less than a predetermined amount of hesitation or deviation from a fastest path to the respective destination.

According to some embodiments, the program code instructions to determine, from the probe data, a baseline mobility model includes program code instructions to: determine local probe apparatuses of the plurality of first probe apparatuses to be of a predetermined familiarity with the geographic region; and identify routes between origin and destination pairs as efficient routes between the origin and destination pairs in response to the routes being traversed by local probe apparatuses. The program code instructions to determine local probe apparatuses of the plurality of first probe apparatuses to be of a predetermined familiarity with the geographic region of some embodiments includes program code instructions to identify probe apparatuses of the plurality of first probe apparatuses that travel along paths to a respective destination with less than a predetermined amount of hesitation or deviation from a fastest path to the respective destination.

According to some embodiments, the program code instructions to determine, based at least in part on the baseline mobility model, a mobility efficiency of the second mobility model includes program code instructions to; determine deviations of the second mobility model from the baseline mobility model within the geographic region; and quantify the deviations of the second mobility model from the baseline mobility model. Some embodiments provided herein include program code instructions to: provide route recommendations to a user of the second probe apparatus for a route to a destination that is at least one of faster or less costly than a planned route of the user of the second probe apparatus.

Some embodiments provided herein include program code instructions to provide a recommendation of a sub-region of the geographic region that a user of the second probe apparatus is determined to be unfamiliar with. Embodiments may include program code instructions to determine the user of the second probe apparatus to be unfamiliar with the sub-region of the geographic region in response to less than a predetermined threshold of probe data from the second probe apparatus being associated with locations within the sub-region of the geographic region.

Embodiments provided herein may include a method including: receiving probe data from a plurality of first probe apparatuses within a geographic region; determining, from the probe data, a baseline mobility model; receiving probe data from a second probe apparatus within the geographic region; determining a second mobility model of the second probe apparatus; determining, based at least in part on the baseline mobility model, a mobility efficiency of the second mobility model; and generating a report related to the mobility efficiency of the second mobility model. The baseline mobility model may include a model of mobility within the geographic region established to be representative of efficient movement within the geographic region.

According to some embodiments, determining, from the probe data, a baseline mobility model may include: determining local probe apparatuses of the plurality of first probe apparatuses to be of a predetermined familiarity with the geographic region; and identifying routes between origin and destination pairs as efficient routes between the origin and destination pairs in response to the routes being traversed by local probe apparatuses. According to some embodiment, determining local probe apparatuses of the plurality of first probe apparatuses to be of a predetermined familiarity with the geographic region includes: identifying probe apparatuses of the plurality of first probe apparatuses that travel along paths to a respective destination with less than a predetermined amount of hesitation or deviation from a fastest path to the respective destination.

Embodiments provided herein may include an apparatus including: means for receiving probe data from a plurality of first probe apparatuses within a geographic region; means for determining, from the probe data, a baseline mobility model; means for receiving probe data from a second probe apparatus within the geographic region; means for determining a second mobility model of the second probe apparatus; means for determining, based at least in part on the baseline mobility model, a mobility efficiency of the second mobility model; and means for generating a report related to the mobility efficiency of the second mobility model. The baseline mobility model may include a model of mobility within the geographic region established to be representative of efficient movement within the geographic region.

According to some embodiments, the means for determining, from the probe data, a baseline mobility model may include: means for determining local probe apparatuses of the plurality of first probe apparatuses to be of a predetermined familiarity with the geographic region; and means for identifying routes between origin and destination pairs as efficient routes between the origin and destination pairs in response to the routes being traversed by local probe apparatuses. According to some embodiments, the means for determining local probe apparatuses of the plurality of first probe apparatuses to be of a predetermined familiarity with the geographic region includes: means for identifying probe apparatuses of the plurality of first probe apparatuses that travel along paths to a respective destination with less than a predetermined amount of hesitation or deviation from a fastest path to the respective destination.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example architecture of an example embodiment described herein;

FIG. 2 is a block diagram of an apparatus that may be specifically configured in accordance with an example embodiment of the present disclosure;

FIG. 3 illustrates a map depicting sub-regions within a geographic region corresponding to different degrees of familiarity from a user according to an example embodiment of the present disclosure;

FIG. 4 depicts a plot of efficiency of a local and a non-local over time within a geographic region according to an example embodiment of the present disclosure; and

FIG. 5 is a flowchart of a method for determining the mobility efficiency of a person within a geographic area according to an example embodiment of the present disclosure.

### DETAILED DESCRIPTION OF SOME EXAMPLE EMBODIMENTS

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Methods, apparatus and computer program products are provided in accordance with an example embodiment in order to determine the degree of familiarity of a user with a geographic region and to determine a mobility efficiency index of people not familiar with a geographic region that can be leveraged to improve the familiarity of the people with the geographic region. A mobility efficiency index of example embodiments is established to define mobility patterns of people familiar with a geographic region. Through analysis of individuals that are familiar with the region, the most efficient and effective routes within the region to destinations can be established. Further, the preferred destinations of people “local” or familiar with a geographic region can be identified and used for recommendations to those unfamiliar with the geographic region. Embodiments provide a system that enables users to benefit from routing capabilities that leverage insights from “locals” by learning how people familiar with a geographic region navigate in the geographic region. The term “locals” or a user “local” to a geographic area is defined herein to be someone determined to be “familiar” with a geographic region or having at least a predefined degree of familiarity with the geographic region. Methods of establishing familiarity will be described further below.

While example embodiments described herein may leverage pedestrian-based probe data, embodiments may be used for any form of mobility data and any form of transportation as will be appreciated by one of ordinary skill in the art.

According to an example embodiment described herein, a baseline mobility model is generated based on probe data from people of at least a predefined degree of familiarity or “familiar” with a geographic region. This baseline mobility model is considered as the optimal route strategy taken by local people, even if the route is not the fastest, shortest, or lowest cost. Using the baseline mobility model, mobility patterns of a user or a user mobility model may be compared to the baseline mobility model to determine a local mobility efficiency index. The deviation of the user mobility model from the baseline mobility model is the deviation of the user from the optimal route determined by local intelligence to establish the local mobility efficiency index. The greater the deviation of the user mobility model from the baseline mobility model, the lower the mobility efficiency index.

According to embodiments described herein, once a mobility efficiency index for a user has been determined for a geographic region, the user may be presented with recommendations for routes to destinations or areas of interest that can improve the efficiency of the user in traversing the geographic region and improve their mobility efficiency index for the geographic region. The mobility efficiency index could be employed to guide tourists like locals in areas where they are not necessarily familiar. Embodiments can further identify sub-regions within the geographic region that a user has not explored based on a lack of probe data from the user in the sub-regions. Recommendations can be presented to the user for traveling within these sub-regions in order to improve their mobility efficiency index for the geographic regions. According to such embodiments, recommendations may be provided to a user to visit points of interest or areas of a region that a user may not have otherwise been motivated to visit. Color-coded maps or otherwise visually distinguished maps may present a visual interface to a user that illustrates sub-regions within a geographic region and how familiar the user is with those sub-regions. Once a user becomes familiar with a sub-region (e.g., their mobility efficiency index satisfies a predetermined value), the sub-region may change color indicating the degree of familiarity with the sub-region.

Embodiments described herein gather probe data from probe apparatuses of people that are familiar with a geographic region. The mobility patterns of these “locals” are analyzed over time to learn the most efficient paths and most popular routes and points of interest of the locals. This becomes the baseline model for the mobility efficiency index. Probe data is gathered from probe apparatuses (e.g., mobile phones as described further below) of users and analyzed to determine a mobility model for the users. This probe model is compared against the baseline mobility model to establish the mobility efficiency index for each user. The mobility efficiency index can be employed to benefit the user through various methods as described herein.

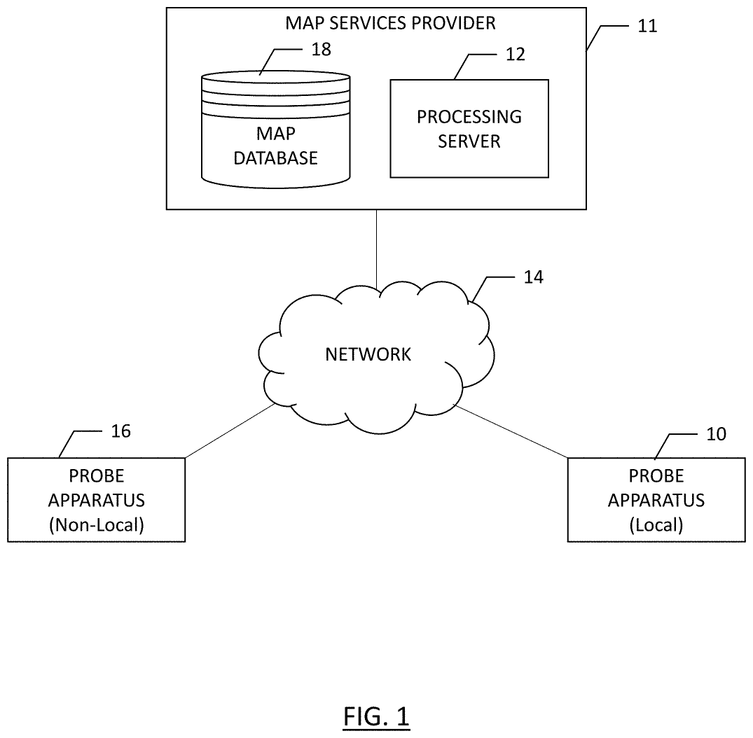

To generate a mobility efficiency index for a user, a system as illustrated in FIG. 1 may be used. FIG. 1 illustrates a communication diagram of an example embodiment of a system for implementing example embodiments described herein. The illustrated embodiment of FIG. 1 includes a map services provider 11, a processing server 12, and a map database 18. As shown, the map services provider 11 may be in communication via a network 14, such as a wide area network, such as a cellular network, the Internet, or a local area network. However, the map services provider 11 may be in communication with the other elements of the system in other manners, such as via direct connection through direct communications between the map services provider 11 and data sources.

Examples of the probe data sources as described herein include a local probe apparatus 10 and a non-local probe apparatus 16. Both the local probe apparatus 10 and the non-local probe apparatus 16 may be a source of mobility data, such as a mobile device and may be embodied by a number of different devices including mobile computing devices, such as a personal digital assistant (PDA), mobile telephone, smartphone, laptop computer, tablet computer, vehicle navigation system, infotainment system, in-vehicle computer, or any combination of the aforementioned.

The processing server 12 of the map services provider 11 may also be embodied by a computing device and, in one embodiment, is embodied by a web server. Additionally, while the system of FIG. 1 depicts a single map services provider 11 and two probe apparatuses, systems of example embodiments may include any number of probe apparatus, any number of map services providers, any number of databases, and any number of processing servers, which may operate independently or collaborate to support activities of the embodiments described herein.

The map database 18 may include one or more databases and may include information such as geographic information relating to road networks, points-of-interest, buildings, etc. Further, the map database 18 may store therein historical dynamic population or mobility data, such as historical traffic data, mobile device data, monitored area data (e.g., closed-circuit television), or the like. Thus, the map database 18 may be used to facilitate the quantifying and measuring of human mobility within defined geographic regions and sub-regions to establish familiarity with a geographic region.

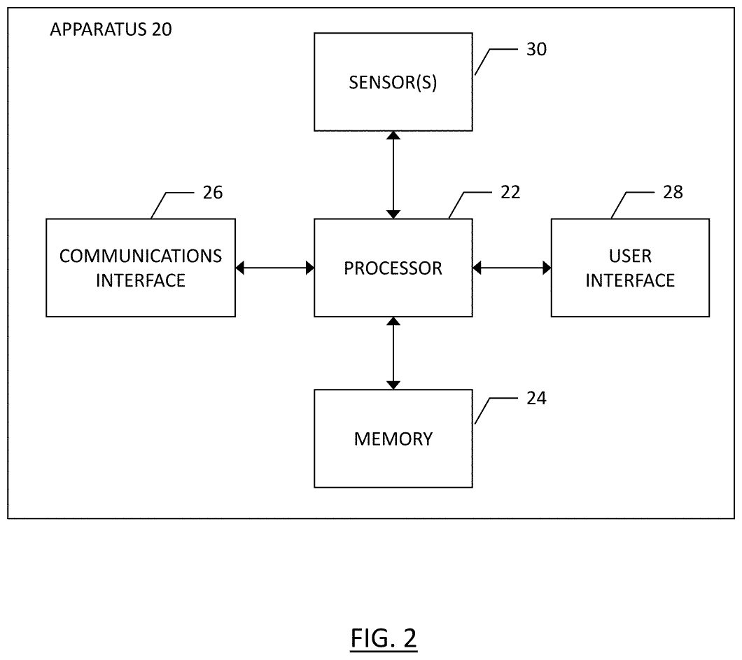

Regardless of the type of device that embodies the local probe apparatus 10 or the non-local probe apparatus 16, the probe apparatus may be embodied as an apparatus 20 as shown in FIG. 2. In this regard, the apparatus 20 may include or otherwise be in communication with a processor 22, a memory device 24, a communication interface 26 and a user interface 28. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device 24 may include, for example, one or more volatile and/or non-volatile memories. In other words, for example, the memory device 24 may be an electronic storage device (e.g., a computer readable storage medium) comprising gates configured to store data (e.g., bits) that may be retrievable by a machine (e.g., a computing device like the processor). The memory device 24 may be configured to store information, data, content, applications, instructions, or the like for enabling the apparatus 20 to carry out various functions in accordance with an example embodiment of the present invention. For example, the memory device 24 could be configured to buffer input data for processing by the processor 22. Additionally or alternatively, the memory device could be configured to store instructions for execution by the processor.

The processor 22 may be embodied in a number of different ways. For example, the processor 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor 22 may include one or more processors configured in tandem via the bus to enable independent execution of instructions, pipelining and/or multithreading.

In an example embodiment, the processor 22 may be configured to execute instructions stored in the memory device 24 or otherwise accessible to the processor 22. Alternatively or additionally, the processor 22 may be configured to execute hard coded functionality. As such, whether configured by hardware or software methods, or by a combination thereof, the processor 22 may represent an entity (e.g., physically embodied in circuitry) capable of performing operations according to an embodiment of the present invention while configured accordingly. Thus, for example, when the processor 22 is embodied as an ASIC, FPGA or the like, the processor 22 may be specifically configured hardware for conducting the operations described herein. Alternatively, as another example, when the processor 22 is embodied as an executor of software instructions, the instructions may specifically configure the processor 22 to perform the algorithms and/or operations described herein when the instructions are executed. However, in some cases, the processor 22 may be a processor of a specific device (e.g., a head-mounted display) configured to employ an embodiment of the present invention by further configuration of the processor 22 by instructions for performing the algorithms and/or operations described herein. The processor 22 may include, among other things, a clock, an arithmetic logic unit (ALU) and logic gates configured to support operation of the processor 22. In one embodiment, the processor 22 may also include user interface circuitry configured to control at least some functions of one or more elements of the user interface 28.

Meanwhile, the communication interface 26 may include various components, such as a device or circuitry embodied in either hardware or a combination of hardware and software that is configured to receive and/or transmit data between a computing device (e.g. probe apparatus 10 or 16) and a processing server 12. In this regard, the communication interface 26 may include, for example, an antenna (or multiple antennas) and supporting hardware and/or software for enabling communications wirelessly. Additionally or alternatively, the communication interface 26 may include the circuitry for interacting with the antenna(s) to cause transmission of signals via the antenna(s) or to handle receipt of signals received via the antenna(s). For example, the communications interface 26 may be configured to communicate wirelessly with a head-mounted display, such as via Wi-Fi (e.g., vehicular Wi-Fi standard 802.11p), Bluetooth, mobile communications standards (e.g., 3G, 4G, or 5G) or other wireless communications techniques. In some instances, the communication interface 26 may alternatively or also support wired communication. As such, for example, the communication interface 26 may include a communication modem and/or other hardware/software for supporting communication via cable, digital subscriber line (DSL), universal serial bus (USB) or other mechanisms. For example, the communication interface 26 may be configured to communicate via wired communication with other components of a computing device.

The user interface 28 may be in communication with the processor 22, such as the user interface circuitry, to receive an indication of a user input and/or to provide an audible, visual, mechanical, or other output to a user. As such, the user interface 28 may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface 28 may also be in communication with the memory 24 and/or the communication interface 26, such as via a bus.

The communication interface 26 may facilitate communication between different user devices and/or between the processing server 12 and apparatuses 10 or 16. The communications interface 26 may be capable of operating in accordance with various first generation (1G), second generation (2G), 2.5G, third-generation (3G) communication protocols, fourth-generation (4G) communication protocols, fifth-generation (5G) communication protocols, Internet Protocol Multimedia Subsystem (IMS) communication protocols (e.g., session initiation protocol (SIP)), and/or the like. For example, a mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like.

The apparatus 20 of example embodiments, particularly when embodying a probe apparatus, may further include one or more sensors 30 which may include location sensors, such as global positioning system (GPS) sensors, sensors to detect wireless signals for wireless signal fingerprinting, sensors to identify an environment of the apparatus 20 such as image sensors for identifying a location of the apparatus 20, or any variety of sensors which may provide the apparatus 20 with an indication of location.

While the apparatus 20 is shown and described to correspond to a probe apparatus, embodiments provided herein may include a user device that may be used for a practical implementation of embodiments of the present disclosure. For example, such an apparatus may include a laptop computer, desktop computer, tablet computer, mobile phone, or the like. Each of which may be capable of providing a graphical user interface (e.g., presented via display or user interface 28) to a user for interaction with a map providing mobility information, navigation information, point of interest information, etc. for geographic regions as described further below. Embodiments of the apparatus may include components similar to those as shown in FIG. 2 through which a user may interact with mobility data presented on the display of a user interface for a device, such as apparatus 20.

Embodiments described herein relate to establishing a mobility efficiency index that is based on learning the mobility patterns of locals, or people that have at least a predefined familiarity with a geographical region. The mobility efficiency index can be leveraged to provide the benefit of local knowledge to people who are unfamiliar with the geographic region. Using knowledge established from locals, users that are determined to be unfamiliar with an area may be given routing recommendations, point of interest recommendations, or other information that may benefit the user and may improve the user's familiarity with the region, thereby improving the user's mobility efficiency index. Quantifying mobility efficiency is difficult; however, embodiments of the present disclosure include a method to establish a baseline mobility model using the knowledge and mobility patterns of locals, and to compare the mobility of a user with that of locals to establish mobility efficiency. Quantifying a user's mobility efficiency enables that user to benefit from routing capabilities that leverage insights from locals by learning how the people familiar with a geographic region navigate the geographic region.

To quantify mobility efficiency, the baseline mobility model must be established based on the mobility of people familiar with a geographic region. Further, it must be established as to who is sufficiently familiar with a geographic region to contribute to the baseline mobility model. Familiarity and the degree thereof can be established through a variety of sources of information. Easily interpreted and reliable information regarding users and their familiarity with a geographic region may include a user address, user work location, or other information that ties a user to a particular location. Further, natural language processing through analysis of messages to and from a user may provide an indication of a degree of familiarity of a person with a specific geographic region. However, this information is often unavailable due to privacy concerns and may not be readily available to third party service providers such as a map services provider 11, particularly if the user is not a subscriber or client of the map services provider.

A degree of familiarity of a person with a geographic region may be established without requiring personal information or information identifying the person. Mobility data can be used to determine a degree of familiarity of a person with a geographic region. For example, people more familiar with an area generally hesitate less when moving and have less frequent heading changes or pauses. People more familiar with an area tend to travel straight to their destination, make fewer mistakes, take routes repeatedly, take more shortcuts (e.g., lower volume paths, or more restrictive paths (e.g., narrower alleys, more turns, etc.). Each of these types of movement may be used to generate a measure of the degree of familiarity of a person with the geographic region in which they are traveling. Other mobility information from a probe apparatus of a person that may indicate the degree of familiarity with the geographic region may include the use of a parking structure limited to residents or account holders, the use of certain public transit routes (e.g., routes not including tourist destinations, airports, or train stations), or similar mobility information that would indicate that a person is a local to the region.

Mobility patterns of a user may provide an indication of the degree of familiarity of a person with a region. Patterns such as the dwell time at specific points of interest, adherence to travel restrictions (e.g., a person unfamiliar with an area is more likely to use only crosswalks to cross streets), avoidance touristic points of interest, avoidance of crowded places, wander less, etc. Each of these mobility patterns may be used to help establish the degree of familiarity of a person with a geographic region.

The degree of familiarity of a person with a geographic region can be derived from a combination of the insights detailed above. The mobility data and mobility patterns described above with respect to establishing the familiarity of a person with a geographic region may not, individually, be a reliable indicator of familiarity. However, a combination of the mobility data and mobility patterns may provide a reliable indicator, or an indicator with greater confidence of the degree of familiarity of the person with the geographic region.

To determine a degree of familiarity of a person with a geographic region, a classification algorithm may be employed such as using a Decision Tree, Random Forest, or Logistic Regression, for example. A model may be trained with a dataset including features that relate to whether an individual is familiar with an area. These features, as referenced above, may include a degree or amount of hesitation, the straightness of a path along a route, mistakes made along a route, efficiency of a path taken to a destination, access to places requiring membership (e.g., a parking pass for a garage), shorter dwell time at points of interest, avoiding touristic points of interest, avoiding crowded areas, non-hotel or transit hub origins (e.g., airports, train stations, etc.), or the like. The model can be trained using ground truth labels of local people versus tourists, where ground truth is factually known. Locals have at least a predefined degree of familiarity with a geographic location, while “tourists” or non-locals fall below this predefined degree. In the training dataset for the model, each tuple would include all of the features defining the degree of familiarity with a geographic region in addition to the ground truth label of whether the person is a local or a tourist. Several tuples would be in the training dataset.

The training of the model used to determine the degree of familiarity may use an algorithm such as a Decision Tree, Random Forest, Logistic Regression. The training data may be split where a portion is used for training, and another portion is used for testing. For example, 70% of the training data may be for training, with 30% used for testing. As the training data has ground truth labels for locals versus tourists, the accuracy of the model can be ascertained. The ground truth labels are removed from the testing data for the testing process. When the accuracy is above a predefined threshold, such as around 70%, the model is sufficiently accurate to be deployed. The final number of tuples in the dataset may be determined when the model results do not indicate overfitting. In the deployed model, the same mobility features are collected as used in the training data and the model makes a prediction with respect to whether the person associated with the mobility data is a tourist or a local based on their movements. The degree of familiarity of people within a geographic area may have a temporal component, where familiarity is established relative to a historical period, such as based on an average familiarity level over a rolling window, such as a trailing 12-month period.

According to an example embodiment, a user may require real-time or near real-time information when the goal is to deliver location-based recommendations the user. In such a scenario, an analysis of the probe data in the cloud may be used to determine the familiarity level, and an analysis of the probe data of the user's apparatus directly on the user's apparatus can determine the user's familiarity level without sending confidential information to a central server. This edge computing method may be useful for real-time evaluation of the familiarity of a user within a geographic region when historical mobility data for the user may not be available.

According to example embodiments provided herein, the familiarity of a user within a geographic region may be established based on historical mobility data from the user. Embodiments may collect historical and/or real-time information about a user's movement. The mobility data of the user is analyzed through the mobility features as described above. A familiarity level of the user for the respective geographic region can then be computed. The familiarity level can then be used to support various types of information, help, support, recommendations, etc. The familiarity level of a user may be monitored and may evolve with time as a user becomes more familiar with a geographic region.

In establishing the familiarity of a user within a geographic region, a mobility efficiency index may be calculated for the user. A baseline mobility model for a geographic region is established. The baseline mobility model may be established as described above where people whose mobility indicates that they have at least a predefined degree of familiarity with the geographic region are established as locals. This baseline mobility model constructed using mobility data from people established as locals includes paths between origins and destinations, points of interest, paths for avoiding crowded areas or tourist areas, and other types of movement that would be associated with people familiar with the geographic region.

Once this baseline mobility model for a geographic region is established, the mobility efficiency index of an individual can be computed. To compute the mobility efficiency index, the mobility data from a user may be used to create a mobility model of the user including paths taken, points of interest visited, dwell/hesitation times, etc. The user's mobility model is compared against the baseline mobility model to establish a mobility efficiency index representing the efficiency with which the user moves within the geographic region. Deviation of the user's mobility model from the baseline mobility model lowers the mobility efficiency index, while movement of a user that coincides with movement of locals (e.g., where the user's mobility model more closely matches the baseline mobility model) increases the mobility efficiency index of the user.

Once the mobility efficiency index has been calculated for a user, embodiments described herein can use this index to determine what information to provide to the user. Embodiments can proactively make recommendations to a user and provide guidance on how to improve the user's mobility efficiency index. The mobility efficiency index can be employed to guide a tourist like a local in an area that the user is not familiar.

According to an example embodiment, the mobility efficiency index may be used to guide a user within a sub-region of a geographic region to explore the area until the mobility efficiency index for the user in the sub-region improves to a predetermined level indicating that the user has achieved at least a minimum degree of familiarity with the sub-region. Once the user has become at least this familiar with the sub-region, embodiments described herein may recommend another sub-region for the user to explore. The guidance to a user may be provided on a user interface, such as user interface 28 of apparatus 20 of FIG. 2, and may be provided in the form of notifications, for example. Optionally, a user interface may depict a map showing the user's location and the sub-region. When the user is familiar with a sub-region, the visual appearance of the sub-region on the map may change to reflect that the user is now familiar with that sub-region. This may provide a user a visual indication of how much of a geographic area they are familiar with. The mobility efficiency index can be used to trigger contextual suggestions an recommendations, such as to extend time in an area, or to move on to a new area.

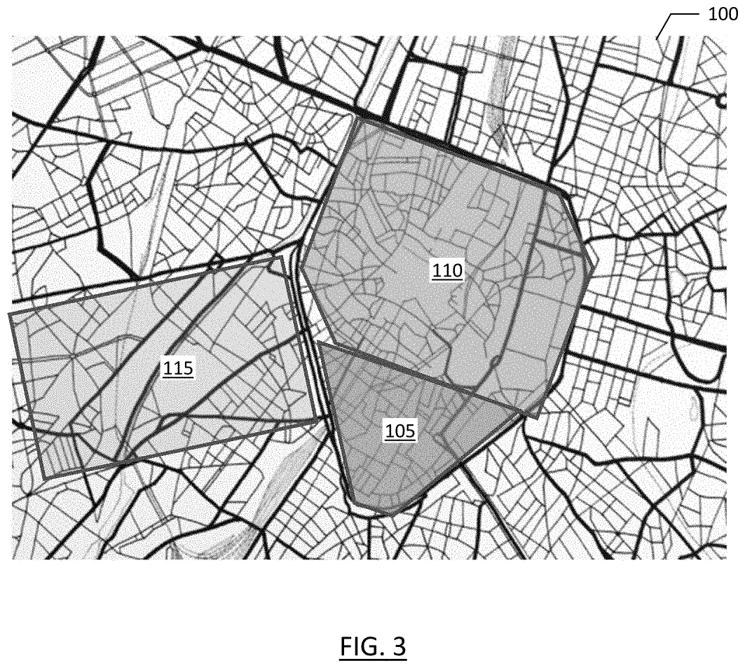

The visual depiction of a user's mobility efficiency index of a sub-region within a geographic region may be depicted in a gradient form, where a user interface may present a map depicting several sub-regions within the geographical region, with some visual indication of the mobility efficiency index of the user in those sub-regions. FIG. 3 illustrates an example embodiment in which a map 100 may be presented on a user interface (e.g., user interface 28) with three sub-regions shown within a geographic area, and the sub-regions having different shading. Sub-region 105 having the darkest shading may be the most familiar to a user with the user's mobility efficiency index being relatively high. Sub-region 115 is most transparent, indicating the user's mobility efficiency index is relatively low, whereas sub-region 110 has a moderate degree of shading indicating a moderate mobility efficiency index. While shading is illustrated in the figure, any visual distinction for sub-regions may be employed, such as a color of the map elements within a sub-region, a border of a mapped sub-region, or the like.

Embodiments described herein may be used to understand the ratio of tourists to locals in an area by identifying the ratio of people with a high mobility efficiency index (locals) versus those with low mobility efficiency index (tourists). This ratio may have a variety of uses, such as to identify good locations for certain types of stores/restaurants. For example, if an area has a high ratio of tourists regularly or over time, it may be a good location for tourist-oriented retailers. Further, this information may be useful to city planners for transit (e.g., new transit routes) and to locals to understand which areas they may wish to avoid. This information may also be beneficial to tourists, as if a tourist sees a restaurant area that is primarily locals, they may recognize that the approval of the restaurants by locals suggests a high quality of restaurant.

The mobility efficiency index of example embodiments may be context dependent. The mobility efficiency index may vary based on time of day, weather conditions, traffic conditions or road closures, events, or the like. For example, a person who is very familiar with a downtown area for work may have a high degree of familiarity on weekdays in the downtown area. However, outside of working hours, such as on evenings and weekends, the user may not be as familiar with the area as traffic patterns may change, different businesses may be operating, the demographics of crowds may be different, etc.

The mobility efficiency index calculated by example embodiments described herein can be leveraged to inform a person not familiar with an area of recommendations and routes that may improve the user's mobility efficiency. For example, locals may understand that a certain area or road becomes congested on days that have nice weather (e.g., a road near a park) such that on warm, sunny days a recommendation may be made to a non-local that they avoid this area or road. Locals may avoid certain areas due to a perceived or real elevated crime risk (e.g., due to lack of street lighting), such that a recommendation to a non-local may recommend a route around such an area. Locals may avoid other areas for a variety of reasons—e.g., tourist traffic with people abruptly stopping, pedestrian paths that are congested with bikes, dirty pedestrian paths, or the like. Embodiments described herein can leverage the knowledge of locals even when the locals may not think about why they are avoiding an area. This provides recommendations to non-locals leveraging the mobility patterns of the locals.

While embodiments may recommend areas to avoid or paths that deviate around certain areas, embodiments may leverage more efficient paths taken by locals that may not be readily apparent to non-locals. For example, in a city, there may be elevated, covered walkways between buildings that provides a sheltered path through city blocks without concern for traffic or weather. While such a feature may be well-known to people living/working in the city, a tourist may be unaware of these elevated/covered walkways. Embodiments of the present disclosure may provide a recommendation to a user to take such a path as it is evidenced to be taken by locals, particularly in inclement weather or at night. Embodiments may provide routing and recommendations for both indoors and outdoors as mobility may be monitored for all environments, and used to establish a baseline mobility model for all environments.

An algorithm may be used to establish the mobility efficiency index of a user. The mobility features described above are representative of mobility data that may be used to compute the divergence or similarity of a user's mobility model with the baseline mobility model. Each mobility feature is used as an input and is given a weight, where the weight may be determined based on the frequency of occurrence of the input variable in the ground truth samples for the locals identified in training the algorithm. The sum of the weights of all of the inputs (e.g. all of the mobility features) is one. For each input's weight to be considered in the final weight, a threshold needs to be satisfied. For example, an input mobility feature of weather may have a threshold of 0.3 implying that only if the user determines an optimal route during inclement weather, similar to a local's route during inclement weather, at least three of ten times, the user would satisfy the weather threshold and their mobility efficiency index would reflect an increase corresponding to the weight of the weather component of the mobility efficiency index.

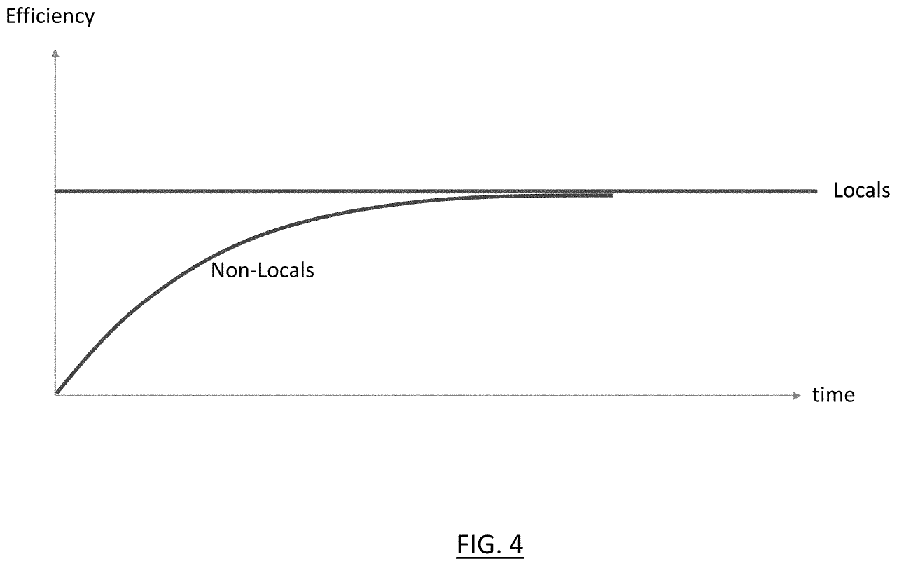

FIG. 4 illustrates the growing familiarity of non-locals with an area over time. As shown, the longer the non-locals spend in a geographic region, the greater their efficiency becomes and their mobility efficiency index increases until they are as familiar with the geographic region as locals.

Embodiments described herein provide a method of identifying devices or apparatuses (e.g., apparatus 20) associated with people within a geographic region that have at least a predefined degree of familiarity with the geographic region, and to use the mobility models associated with those people to define a baseline mobility model that represents the more efficient, optimal, and/or desirable routes and points of interest of the geographic region. From this baseline mobility model, a mobility efficiency index can be calculated for the mobility data from the apparatus of a user in the geographic region. The more similar the mobility data associated with the user is to the baseline mobility model, the higher the mobility efficiency index. The mobility efficiency index can be context dependent, and may provide recommendations to a user who has less than a predefined degree of familiarity with a geographic region. A global mobility index may be calculated that sums all individual mobility data for a geographic region to identify the overall degree of familiarity with the geographic region, and the proportions of people with differing degrees of familiarity.

Embodiments described herein relate to measuring and quantifying human mobility, and more particularly, to determining the familiarity of a person with a geographic region based on mobility data, and leveraging the familiarity to inform those less familiar and to inform travel within the geographic region. By using a baseline mobility index established from people who are determined to have at least a predefined degree of familiarity with a geographic region, a mobility efficiency index can be established for individuals, and assistance can be offered to individuals determined to have a low degree of familiarity with the geographic region.

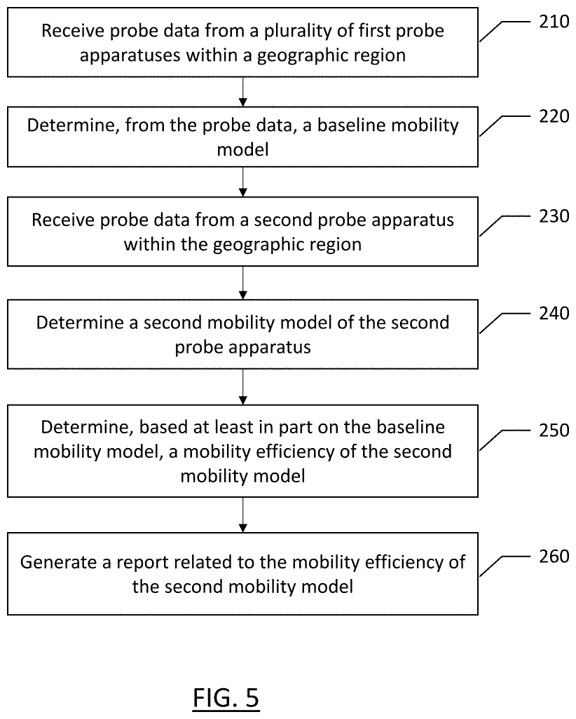

FIG. 5 illustrates a flowchart of a method for quantifying and measuring human mobility, and more particularly, to determining the familiarity of a person with a geographic area based on their mobility data compared against baseline mobility data, and leveraging the familiarity to inform those less familiar and to inform travel within the geographic area. As shown at 210, probe data is received from a plurality of first probe apparatuses within a first geographic region. These first probe apparatuses are represented by local probe apparatus 10 of FIG. 1. From the probe data, a baseline mobility model is determined at 220. Probe data is then received from a second probe apparatus within the geographic area as shown at 230. The second probe apparatus is represented by non-local probe apparatus 16 of FIG. 1. A second mobility model of the second probe apparatus is determined from the probe data of the second probe apparatus at 240. Based, at least in part on the baseline mobility model, a mobility efficiency of the second mobility model is determined at 250. A report related to the mobility efficiency of the second mobility model is then generated at 260. The report may include a variety of data and information to be provided to a user or to a device or apparatus. In some aspects, the report may include instructions relating to mobility, and more specifically, instructions relating to improving mobility efficiency.

As described above, FIG. 5 illustrates a flowchart of apparatuses 20, methods, and computer program products according to an example embodiment of the disclosure. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 24 of an apparatus employing an embodiment of the present invention and executed by the processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the method of FIG. 9 above may comprise a processor (e.g., the processor 22) configured to perform some or each of the operations (210-260) described above. The processor may, for example, be configured to perform the operations (210-260) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 210-260 may comprise, for example, the processor 22 and/or a device or circuit for executing instructions or executing an algorithm for processing information as described above.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to at least:
receive probe data from a plurality of first probe apparatuses within a geographic region;
determine, from the probe data, a baseline mobility model;
receive probe data from a second probe apparatus within the geographic region;
determine a second mobility model of the second probe apparatus;
determine, based at least in part on the baseline mobility model, a mobility efficiency of the second mobility model; and
generate a report related to the mobility efficiency of the second mobility model.

2. The apparatus of claim 1, wherein the baseline mobility model comprises a model of mobility within the geographic region established to be representative of efficient movement within the geographic region.

3. The apparatus of claim 2, wherein causing the apparatus to determine, from the probe data, a baseline mobility model comprises causing the apparatus to:
determine local probe apparatuses of the plurality of first probe apparatuses to be of a predetermined familiarity with the geographic region; and
identify routes between origin and destination pairs as efficient routes between the origin and destination pairs in response to the routes being traversed by local probe apparatuses.

4. The apparatus of claim 3, wherein causing the apparatus to determine local probe apparatuses of the plurality of first probe apparatuses to be of a predetermined familiarity with the geographic region comprises causing the apparatus to:
identify probe apparatuses of the plurality of first probe apparatuses that travel along paths to a respective destination with less than a predetermined amount of hesitation or deviation from a fastest path to the respective destination.

5. The apparatus of claim 2, wherein causing the apparatus to determine, based at least in part on the baseline mobility model, a mobility efficiency of the second mobility model comprises causing the apparatus to:
determine deviations of the second mobility model from the baseline mobility model within the geographic region; and
quantify the deviations of the second mobility model from the baseline mobility model.

6. The apparatus of claim 1, wherein the apparatus is further caused to:
provide route recommendations to a user of the second probe apparatus for a route to a destination that is at least one of faster or less costly than a planned route of the user of the second probe apparatus based, at least in part, on the mobility efficiency of the second mobility model.

7. The apparatus of claim 1, wherein the apparatus is further caused to:
provide a recommendation of a sub-region of the geographic region that a user of the second probe apparatus is determined to be unfamiliar with based, at least in part, on the mobility efficiency of the second mobility model.

8. The apparatus of claim 7, wherein the apparatus is further caused to determine the user of the second probe apparatus to be unfamiliar with the sub-region of the geographic region in response to less than a predetermined threshold of probe data from the second probe apparatus being associated with locations within the sub-region of the geographic region.

9. A computer program product comprising at least one non-transitory computer-readable storage medium having computer-executable program code instructions stored therein, the computer-executable program code instructions comprising program code instructions to:
receive probe data from a plurality of first probe apparatuses within a geographic region;
determine, from the probe data, a baseline mobility model;
receive probe data from a second probe apparatus within the geographic region;
determine a second mobility model of the second probe apparatus;
determine, based at least in part on the baseline mobility model, a mobility efficiency of the second mobility model; and
generate a report related to the mobility efficiency of the second mobility model.

10. The computer program product of claim 9, wherein the baseline mobility model comprises a model of mobility within the geographic region established to be representative of efficient movement within the geographic region.

11. The computer program product of claim 10, wherein the program code instructions to determine, from the probe data, a baseline mobility model comprise program code instructions to:
determine local probe apparatuses of the plurality of first probe apparatuses to be of a predetermined familiarity with the geographic region; and
identify routes between origin and destination pairs as efficient routes between the origin and destination pairs in response to the routes being traversed by local probe apparatuses.

12. The computer program product of claim 11, wherein the program code instructions to determine local probe apparatuses of the plurality of first probe apparatuses to be of a predetermined familiarity with the geographic region comprise program code instructions to:
identify probe apparatuses of the plurality of first probe apparatuses that travel along paths to a respective destination with less than a predetermined amount of hesitation or deviation from a fastest path to the respective destination.

13. The computer program product of claim 10, wherein the program code instructions to determine, based at least in part on the baseline mobility model, a mobility efficiency of the second mobility model comprise program code instructions to:
determine deviations of the second mobility model from the baseline mobility model within the geographic region; and
quantify the deviations of the second mobility model from the baseline mobility model.

14. The computer program product of claim 9, further comprising program code instructions to provide route recommendations to a user of the second probe apparatus for a route to a destination that is at least one of faster or less costly than a planned route of the user of the second probe apparatus based, at least in part, on the mobility efficiency of the second mobility model.

15. The computer program product of claim 9, further comprising program code instructions to provide a recommendation of a sub-region of the geographic region that a user of the second probe apparatus is determined to be unfamiliar with based, at least in part, on the mobility efficiency of the second mobility model.

16. The computer program product of claim 15, further comprising program code instructions to determine the user of the second probe apparatus to be unfamiliar with the sub-region of the geographic region in response to less than a predetermined threshold of probe data from the second probe apparatus being associated with locations within the sub-region of the geographic region.

17. A method comprising:
receiving probe data from a plurality of first probe apparatuses within a geographic region;
determining, from the probe data, a baseline mobility model;
receiving probe data from a second probe apparatus within the geographic region;
determining a second mobility model of the second probe apparatus;
determining, based at least in part on the baseline mobility model, a mobility efficiency of the second mobility model; and
generating a report related to the mobility efficiency of the second mobility model.

18. The method of claim 17, wherein the baseline mobility model comprises a model of mobility within the geographic region established to be representative of efficient movement within the geographic region.

19. The method of claim 18, wherein determining, from the probe data, a baseline mobility model comprises:
determining local probe apparatuses of the plurality of first probe apparatuses to be of a predetermined familiarity with the geographic region; and
identifying routes between origin and destination pairs as efficient routes between the origin and destination pairs in response to the routes being traversed by local probe apparatuses.

20. The method of claim 19, wherein determining local probe apparatuses of the plurality of first probe apparatuses to be of a predetermined familiarity with the geographic region comprises:
identifying probe apparatuses of the plurality of first probe apparatuses that travel along paths to a respective destination with less than a predetermined amount of hesitation or deviation from a fastest path to the respective destination.
